(19) United States
(12) Patent Application Publication
(10) Pub. No.: US 2002/0136400 A1
(43) Pub. Date: Sep. 26, 2002

(54) R-conversion encryption method and system

(76) Inventors: Arif Askerov, Holliston, MA (US); Telman Askerov, Holliston, MA (US); Theodore Datri, Millis, MA (US); Sergey Lebedev, Holliston, MA (US)

Correspondence Address: Sam Pasternack, Choate, Hall & Stewart, Exchange Place, Exchange Place, 53 State Street, Boston, MA, 02109-2891, US

(21) Appl. No.: 09/756,456

(22) Filed: Jan. 8, 2001

(51) Int. Cl. H04K 1/00

(52) U.S. Cl. 380/28

(57) ABSTRACT

Encryption method and system for iteratively, structurally converting a binary sequence into an encrypted final image. A selected transformation algorithm and an alphabet formed from the binary sequence to be converted is applied to an image of the sequence, and a resulting image is coded with an external key. Additional embodiments code portions of the image with extracted, and optionally scrambled, internal identifiers derived stochastically from the image being converted.

### FIELD OF THE INVENTION

The present invention relates generally to a method and system for protecting an information file from unauthorized access, and more specifically to the encryption of any binary file in accordance with an encryption key and algorithm which are highly resistant to discovery through brute force attack or cryptographic analysis. The invention has potential application in the fields of improving the security of data, computer systems, e-mail, virtual private networks and web services.

### BACKGROUND OF THE INVENTION

With the development of computer technology, the storage and transfer of information in digital form has rapidly increased. There are many applications, including electronic mail systems, bank systems and data processing systems, where data must be stored securely and transferred from a sender to an intended receiver without unintended parties being able to interpret the stored and/or transferred message.

In the prior art, a number of cryptographic encoding and decoding techniques are readily available to provide some degree of privacy. One of the most well-known is the Digital Encryption Standard (or “DES”) secret key cryptosystem which was adopted by the National Bureau of Standards, (FIPS PUB 46-2; Data Encryption Standard, Dec. 30, 1993). DES was developed in 1976, and is based upon a Data Encryption Algorithm which exchanges right and left parts of a data block. The right part is formed as a sum—an XOR function of right and left parts, and then the resulting block is coded by shuffling and replacement. The algorithm may be repeatedly applied to the same data block. DES was accepted in a 56-bit key format, but researchers have recently shown that the DES is not “by itself” unbreakable and that the system can be broken in its weaker forms on a personal computer (Bihan and Shamir, Differential Cryptanalysis of DES-Like Cryptosystems, Advances in Cryptology: Proceedings of CRYPTO '90, Springer-Verlag, Berlin, pp. 1-21 (1991)). The National Institute of Standards will soon be replacing the DES with a 256-bit key Advanced Encryption Standard.

Another well-known encryption technique is the public key RSA, which was disclosed in a recently expired U.S. Pat. No. 4,405,829 to Rivest et al. RSA is a member of a family of cryptosystems whose security relies on the difficulty of the integer factorization problem. Although no efficient method for computing a solution to this problem has been discovered, today's computing power demands that the integer requiring factorization be 150 decimal digits (or approximately 500 bits) or more (perhaps as many as 300 decimal digits or 1028 bits) in length to provide a high level of security. (Nichols, Randall K., International Computer Security Association Guide to Cryptography, McGraw-Hill 1999). Other public key systems in use today include Elliptic Curve Cryptosystems, Diffie-Hellman, and discrete log systems.

Languages may be characterized by their letter behavior. Statistical data has been compiled on letter frequencies, vowel relationships with specific consonants, and word characteristics. (Friedman, and Callimahos, Military Cryptanalytics Part I—Volume 2, Laguna Hills, Calif., Aegean Park Press (1985)). These statistics were employed in early classical decryption techniques that recognized that language structures and pattern recognition could be used to decode cipher text into plain text.

The increasing ability of cryptographers using powerful computers to “crack” or “exploit” cryptographic methods and systems once thought impenetrable demonstrates the need for alternatives to systems publicly known and used today.

Accordingly, it is an object of this invention to provide a system and method, referred to as the R-Conversion Method, for implementing a highly secure alternative to currently available encryption systems and methods which is less dependent upon key bit-lengths than many existing methods.

It is a further object to provide the symmetric R-Conversion Method for encoding any binary sequence, whether transmitted or not, into a form ready for decoding by reversing the encryption process employing a deterministic but non-predictable key. The R-Conversion Method disclosed herein is formally independent of statistical characteristics of the language of the initial information. Such characteristics are often employed by cryptographers to “crack” some encryption systems.

### SUMMARY OF THE INVENTION

The present invention, which will hereinafter be referred to as R-conversion, is an encryption system (e.g., a method, apparatus, and computer-executable process steps) for iteratively, structurally converting a binary sequence into a R-converted file of internal identifiers FID_{RC} associated with an encrypted final image G. R-conversion may be applied to any binary sequence. It is based on the concept of self-defined data. That is, an alphabet of transformation AV and a set of internal identifiers K are derived from, and are used to manipulate, the binary sequence to be converted. The firmness of the method is determined at least in part by the length of all keys, and the number of conversion process iterations, algorithms and alphabets, as well as a scrambling function.

The number of conversion function iterations, and the alphabets and algorithms of transformation may all be selected stochastically. Upon each conversion process iteration, a new transformation alphabet is stochastically selected from a multitude of available alphabets formed from the binary sequence to be converted on that iteration. An alphabet is a set of letters (or “quants”) comprised of segments of the binary sequence or its derivatives formed during a quantization process (which is described below).

In one aspect, the invention comprises a method for structurally converting a binary sequence into an encrypted final image G. A first step in this method involves forming an image M of the binary sequence to be converted as a concatenation of two data elements, a tag data element T and a structural data element S. The tag data element T is comprised of information necessary to reverse the R-conversion process (or “decipher”). The structural data element S is comprised of a sequence of logical scales of position coding. A number of conversion function iterations P to be performed is then selected. The selection of P could be stochastic, but alternatively greater method firmness could be achieved by selecting a larger number of iterations P. Then, the following conversion function steps are iteratively performed P times, although not all of the following steps are required to be performed upon every iteration, or in this order:

(a) selecting a transformation algorithm A from a predefined set of transformation algorithms L;

(b) selecting a transformation alphabet AV based upon the structural data element S (through means of the quantization process described below);

(c) applying algorithm A and alphabet AV to structural data element S to form a plurality of logical scales of position coding LSᵢ;

(d) forming a tag data element T comprised of information necessary to reverse the conversion process (contents of a tag data element T are described below);

(e) forming a transformed structural data element S′ comprised of a sequence of the logical scales of position coding (the length of transformed data element S′ is also a stochastic variable due to its dependence on algorithm A and a quantization variable m as described below, however, constraints such as minimum file size could be placed upon it);

(f) selecting an external key K^{x}, which may always be the same key, or alternatively, it may be stochastically selected from a file of external keys K_{EXT} either once, whereby the same external key is used during each iteration, or upon each iteration whereby a different external key is used during each iteration;

(g) coding the tag data element T with external key K^{x} to obtain coded tag data element T″ (here, “coding” preferably refers to a logical XOR operation); and

(h) repeating the steps of the conversion function upon a converted image M′ comprised of a concatenation of the coded tag data element T″ and the transformed structural data element S′.

Finally, an encrypted final image G is formed as a concatenation of the coded tag data element T″ and the transformed structural data element S′ created upon the P^{th} iteration of the conversion function.

The selection of the transformation algorithm A may be stochastic, or depend upon adherence to constraining criteria, such as mathematical, logical or final encrypted image G file size criteria. If a constraining criterion is present, such as a minimal encrypted final image G file size, the algorithm A and quantization variable m (which determines alphabet AV and is discussed below) may require re-selection based on statistical analyses of the binary sequence and/or computations of all possible final image G file sizes resulting from various combinations of algorithms A and quantization variables m. The predefined set of algorithms L may be supplemented or changed periodically, and is comprised of algorithms similar in function and implementation in software and hardware. In this embodiment, tag data element T may contain some or all of the following information: an indication whether a present iteration is the P^{th} (the last iteration); an indicator of a single, repetitively used external key K^{x}; indicators of which external key K^{x} and transformation algorithm A were selected; the letters or quants of alphabet AV; other transformation algorithm A parameters (such as a quant inversion indicator); a length of the first logical scale; and information related to the quantization process, including quantization variable m and the “typeness” of the structural data element S. The order that this information is stored in tag data element T is not critical, but certain algorithms may prefer a particular ordering to facilitate reverse transformation.

In another embodiment, the invention comprises a method for structurally converting a binary sequence into an encrypted final image G comprising a majority of the steps of the first embodiment, but additionally employing one or more internal identifiers. In this embodiment, the conversion function comprises the steps of:

(a) selecting a transformation algorithm A from a predefined set of transformation algorithms L;

(b) selecting a transformation alphabet AV based upon (through means of quantization process described below) the structural data element S;

(c) applying algorithm A and alphabet AV to structural data element S to form a plurality of logical scales of position coding LSᵢ;

(d) forming a tag data element T comprised of information necessary to reverse the conversion process (typical contents of a tag data element T are discussed below);

(e) forming a transformed structural data element S′ comprised of a sequence of the logical scales of position coding (the length of transformed data element S′ is also a stochastic variable due to its dependence on algorithm A and a quantization variable m, however, constraints such as minimum file size could be placed upon it);

(f) stochastically selecting a bit length parameter and a shift parameter which define an internal identifier K within transformed structural data element S′;

(g) coding a portion of the tag data element T with internal identifier K to obtain a partially coded tag data element T′;

(h) selecting an external key K^{x}, which may always be the same key, or alternatively, it may be stochastically selected from a file of external keys K_{EXT} either once, whereby the same external key is used during each iteration, or upon each iteration whereby a different external key is used during each iteration;

(i) coding the partially coded tag data element T′ with external key K^{x} to obtain coded tag data element T″ (preferably, the portion of partially coded tag data element T′ not previously coded with internal identifier will be coded by the external key K^{x});

j) stochastically determining whether to extract internal identifier K from transformed structural data element S′, and if determined necessary, extracting the internal identifier K from transformed structural data element S′ to obtain structural data element S″ and storing internal identifier K in a file of internal identifiers FID; and

(k) repeating the steps of the conversion function upon a converted image M′ comprised of a concatenation of the coded tag data element T″ and either transformed structural data element S′ if internal identifier K was not extracted, or structural data element S″ if internal identifier K was extracted. In this embodiment, encrypted final image G is formed, after the P^{th} iteration, as a concatenation of the coded tag data element T″ and either transformed structural data element S′ if internal identifier K was not extracted, or structural data element S″ if internal identifier K was extracted. In this embodiment, tag data element T should additionally include the internal identifier bit length parameter and shift parameter, and information regarding whether internal identifier K was extracted from structural data element S. If the stochastically selected internal identifier bit length parameter and shift parameters cannot be satisfied within the transformed structural data element S′, new pairs of parameters may be selected until a pair which may be satisfied within S′ are obtained.

In another embodiment, the invention comprises a method for structurally converting a binary sequence into an encrypted final image G comprising a majority of the steps of the second embodiment, but additionally scrambling the selected internal identifier K with a scrambling function selected from a scrambling matrix, in order to obtain a scrambled internal identifier K′. The scrambled internal identifier K′ is then used, as the internal identifier is in the second embodiment, to code a portion of the tag data element T to obtain a partially coded tag data element T′. A similar decision whether to also extract internal identifier K from transformed structural data element S′ is made, but rather than storing internal identifiers K in file FID, scrambled internal identifiers K′ are stored in file FID. The scrambling function is preferably periodically changed, and the scrambling matrix is comprised of a predetermined set of scrambling functions and preferably a long-term key.

In the latter two embodiments, a determination whether to extract an internal identifier K is made upon each iteration. The determination whether to extract internal identifiers Kᵢ at all is preferably made when the number of iterations P is determined. Extracting and storing internal identifiers Kᵢ is not compulsory. But if an internal identifier K is not extracted and stored, an indicator of whether extraction occurred, and the internal identifier K bit length parameter and shift parameter must be stored in tag data element T. Otherwise, decryption (reversing the R-conversion process) would be impossible. Completion of the P^{th} (final) iteration yields a file of internal identifiers FID (or scrambled internal identifiers) and a final encrypted image G comprised of a concatenation of the coded tag data element T″ and transformed structural data element S′ or structural data element S″. The final encrypted image G bears no relation to the non-encrypted data, therefore it does not permit any semantic analysis.

In further embodiment based upon the latter two embodiments, the file of internal identifiers FID (or the file of scrambled internal identifiers) may additionally be structurally converted using an external key K^{x} selected stochastically from the file of external keys K_{EXT} to obtain a structurally converted file FID′. The structurally converted file FID′ may then be transmitted independently from, or together with, the final encrypted image G to a receiver for reversing the R-conversion process. The receiver is expected to have obtained, independently from the present transmittal, an R-converted file of external keys K_{EXT}, and an initial key K_{INIT} that is used only once to reverse the R-conversion process applied to the file of external keys K_{EXT}. In a preferred embodiment, the initial key K_{INIT} is no longer needed after its first use as subsequent new files of external keys may be reverse R-converted using the set of external keys being replaced. The initial key K_{INIT} is not R-converted, but delivery to receiver should be by a secure means. Prior to decoding the final encrypted image G, the receiver first must decrypt the file FID′ using the file of external keys K_{EXT}. In order to decrypt the final encrypted image G, the receiver needs to determine all the variables/parameters of each of the P iterations of the conversion process. While performing this reverse conversion, it is impossible to determine whether one is on the correct path to completing the decryption.

In another embodiment, the invention allows the insertion of user information into the structural data element S during a stochastically selected iteration, thereby allowing for encrypted user authentication and digital signatures.

In another aspect, the present invention comprises computer executable process steps stored on a computer readable medium, the computer executable process steps for structurally converting a binary sequence into an encrypted final image G. The computer executable process steps implement the method embodiments described above. Any suitable storage medium, such as magnetic or optical medium, may be employed.

In another aspect, the present invention comprises an apparatus for structurally converting a binary sequence into an encrypted final image G. The apparatus of the invention comprises a memory element for storing computer executable process steps, a processor for executing computer executable process steps and preferably adapted to communicate on a network, and computer executable process steps which implement the various method embodiments described above.

### BRIEF DESCRIPTION OF THE DRAWINGS

FIG. 1 is a block diagram illustrating a file image M comprised of a concatenation of two data elements, a tag data element T, a structural data element S, and a simple transformation alphabet AV formation employing a quantization parameter m.

FIG. 2 is a block diagram of an embodiment of a tag data element T illustrating the types of information that might comprise the contents of the tag data element.

FIG. 3 is a block diagram illustrating an overall scheme of obtaining an final encrypted image G resulting from R-converting a binary sequence.

FIG. 4 is a block diagram illustrating detailed functional steps in a full embodiment of the invention, including essential and optional steps or functions.

FIG. 5 is a block diagram illustrating a network, or remote receiver, embodiment of R-conversion and the data objects transmitted.

### DETAILED DESCRIPTION

Preferred embodiments of the invention will now be described with reference to the accompanying drawings.

In one aspect, the present invention, which will hereinafter be referred to as R-conversion, is an encryption system (e.g., a method, apparatus, and computer-executable process steps) for iteratively, structurally converting any binary sequence into a R-converted file of internal identifiers associated with an encrypted final image. The method is formally independent of statistical characteristics of the language represented by the initial sequence, and much less dependent upon key length than prior encryption methods. R-conversion may be implemented in software on any operating system. A Windows™ based realization may be made as a DLL (dynamic link library) for other programs to easily use. In a Unix-based system, realization may be made as a static library.

A description of the terminology and concepts necessary for an understanding of R-conversion follows first.

The term “concatenation” means that one bit field is juxtaposed to another.

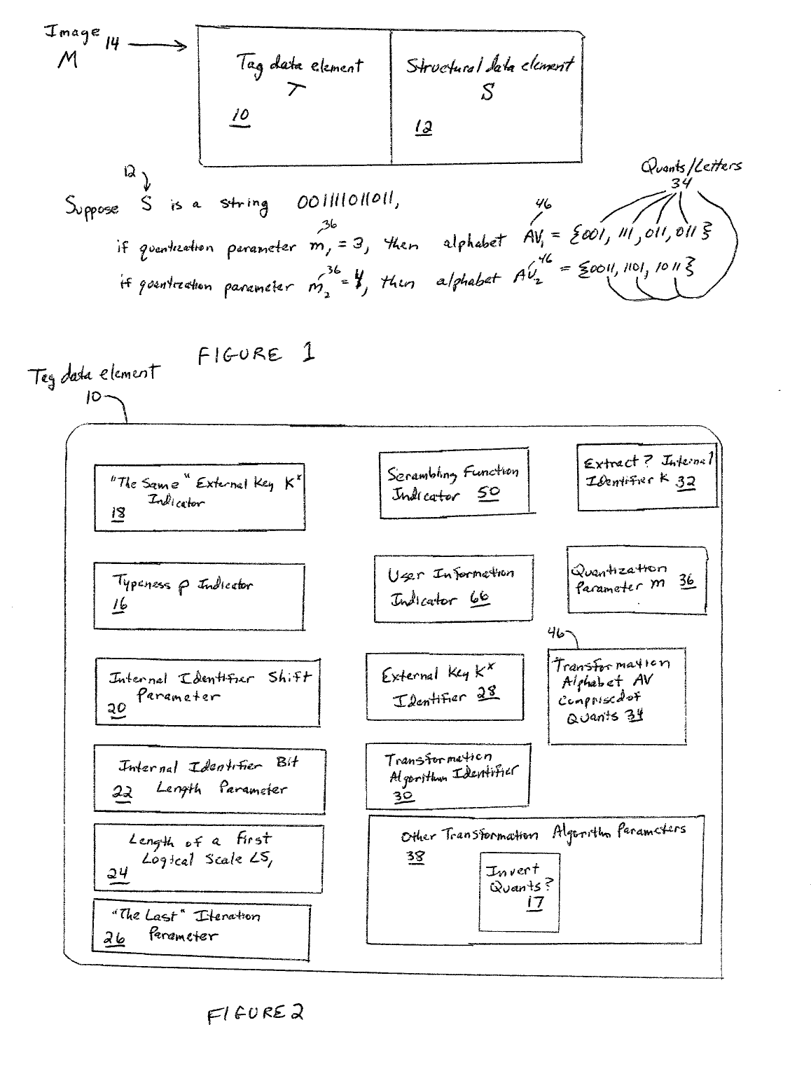

Referring to the examples illustrated in FIG. 1, the term “quants” 34 refers to sequences of bits comprising letters of a transformation alphabet AV 46 formed during a quantization process from a structural data element S 12 of an image M 14 to be structurally converted. Also shown is quantization parameter m 36 employed in the quantization process. As stated above, R-conversion is an iterative method. Upon each iteration, a new quantization parameter m 36 may be selected to facilitate formation of a transformation alphabet AV 46 for that iteration. Alternatively, all the quantization parameters m 36 to be used may be determined at an early stage of the conversion if, for example, constraining criteria so require.

The phrase “logical scale of position coding” refers to positional information designating positions of quants (or letters) 34 within the image M 14.

The term “cartage” refers to a data construct of the R-conversion method. It is comprised of a set of binary sequences.

The phrase “self-defined data” refers to the concept wherein an alphabet of transformation AV 46 and a set of internal identifiers Kᵢ 42 are derived from, and are used to manipulate, the binary sequence to be converted.

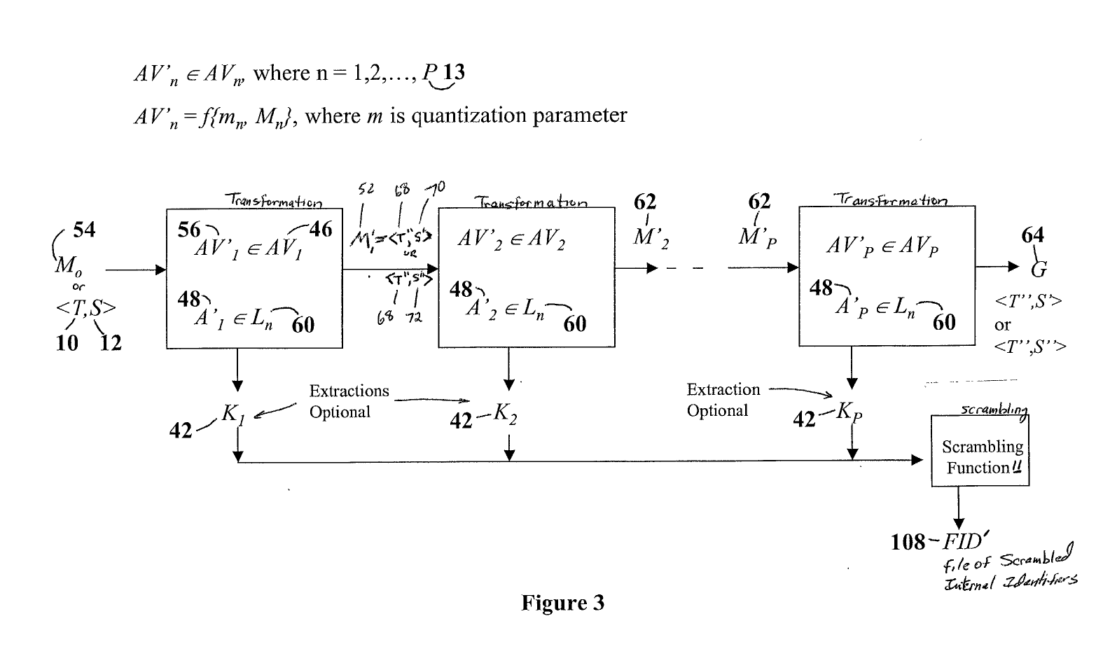

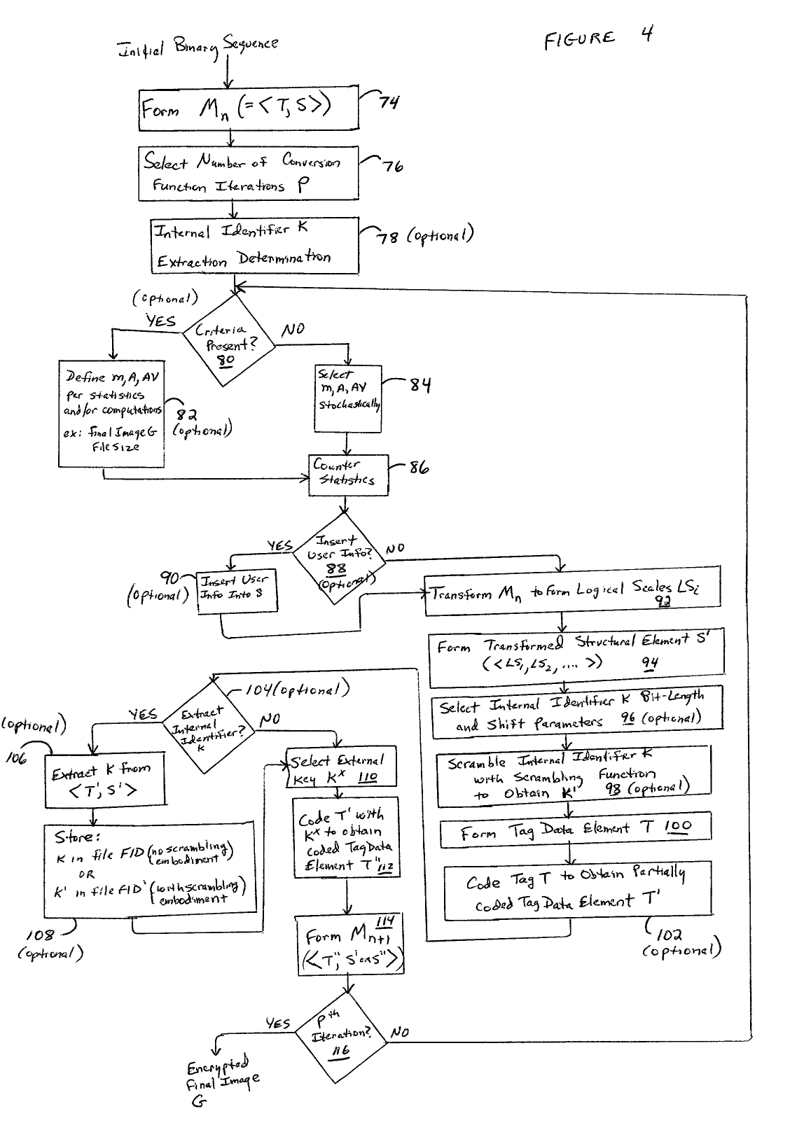

Referring to FIG. 3, the firmness of the encryption system is determined primarily by the lengths of keys and internal identifiers used, a number of conversion function iterations P 13, quantization parameters mᵢ 36, transformation algorithms Aᵢ 48, transformation alphabets AVᵢ 46, and a scrambling function 11. Each of these variables may be selected stochastically. However, R-conversion allows for the establishment of constraining criteria (e.g., logical, mathematical, or file size) that could effect the selection of these variables. For example, if a constraining criterion is present, such as a requirement to obtain an encrypted final image G of minimum file size, the algorithms Ai 48 and quantization parameters mᵢ 36 (which determine alphabet AV as described below) may require re-selection based on statistical analyses of the initial binary sequence and/or computations of all possible final image G file sizes resulting from various combinations of algorithms Aᵢ 48 and quantization parameters mᵢ 36.

What will be described now is a full embodiment of the R-conversion system. Not all the features or steps recited herein are necessary for all embodiments. For example, the use of internal identifiers Kᵢ 42 and scrambled internal identifiers Kᵢ′ 118 are not essential to all R-conversion embodiments.

Referring again to FIG. 1, an image M 14 of a binary sequence may be represented as a concatenation of a tag data element T 10 and a structural data element S 12. FIG. 2 illustrates an embodiment of a tag data element T 10 which is preferably comprised of: a typeness pₘ indicator 16; a “the same?” indicator 18 signifying whether a single external key K^{x} 40 is used for all iterations, or whether a different external key is used for each iteration; an internal identifier bit-length parameter 22 and bit-shift (or position) parameter 20 which together define an internal identifier Kᵢ 42 (shown in FIG. 3) derived from the structural data component S 12 of the image M 14; an indicator of the length of a first logical scale 24 (required because the conversion function will concatenate all newly created logical scales LSᵢ 44 without indicating where one logical scale ends and the next begins, and to reverse the conversion at least the length of the first logical scale must be known, the others may be derived thereafter); a “the last?” bit or bits 26 signifying whether a current iteration is the last required to be performed (the P^{th} iteration); an indicator 50 of the selected scrambling function (only required in embodiments employing scrambling); an indicator 28 of the selected external key K^{x}; an indicator 32 signifying whether the internal identifier K 42 was extracted from the structural data element S 12 on that iteration; an indicator 30 of the selected transformation algorithm A; a set of quants (or letters) 34 which collectively comprise a transformation alphabet AV 46; an indicator 66 of inserted user information (for authentication and digital signature purposes); a quantization parameter m 36; and other non-essential transformation algorithm parameters 38 that might be required for software realization, such as an indicator 17 related to whether the transformation algorithm A 48 of that iteration employed quant inversion. The significance of these parameters will become apparent below, but essentially tag data elements Tᵢ 10 are comprised of all the information necessary to reverse the R-conversion process (described below is additional information that may be placed in the tag data elements Tᵢ 10 to facilitate authentication/digital signatures). The order that these parameters appear in the tag data elements Tᵢ 10 is not critical, however certain algorithms may require a preferred ordering of the letters of the transformation alphabet AV 34 in order to facilitate reverse transformation. Structural data elements Sᵢ 12 are comprised of sequences of logical scales 44 of position coding formed by converting the images Mₙ 62. As illustrated in FIG. 3, subsequent conversions are performed on the images Mₙ 62 (and thus these sequences of logical scales) obtained as output of the previous iteration's conversion.

FIG. 3 represents a simplified view of the R-conversion system. In this aspect, a number of iterations P 13 has been selected, either stochastically or in accordance with a greater or lesser desired method firmness. Blocks representing conversion function iterations produce converted images, such as image M′₁ 52, which is a converted image of initial image M₀ 54, and (optionally) extracted internal identifiers Kᵢ 42. The conversion function applies selected transformation algorithms Aᵢ 48 and a self-defined transformation alphabets AV′₁ 56 to the input image, such as M₀ 54, to obtain converted images, such as M′₁ 52. The transformation algorithms Aᵢ 48 may be selected from a predefined set of algorithms L 60 which may be supplemented or changed periodically. The selection of the transformation algorithm A′₁ 48 may be stochastic, but alternatively may depend upon adherence to constraining criteria such as mathematical, logical or final encrypted image G 64 file size criteria. If a constraining criterion is present, such as a minimal encrypted final image G 64 file size, both the transformation algorithm A′₁ 48 and quantization parameter m 36 (which determines alphabet AV as described below) may require re-selection based on statistical analyses of the input image and/or computations of all possible encrypted final image G 64 file sizes resulting from various combinations of transformation algorithms Aᵢ 48 and quantization variables m 36. Within the structural data element 12 of each image Mₙ (52, 54, and 62), there are a certain number of finite binary strings, one of which may act as an internal identifier K 42 for increasing the method's firmness. Internal identifier K 42 is defined by two stochastically selected parameters (not shown in FIG. 3), a bit length parameter 22 and a shift parameter 20, which refer to a particular binary string within structural data element S 12. Upon each iteration, each input image Mₙ (52, 54, and 62) is converted to obtain a resulting image Mₙ₊₁. And for each iteration of the conversion except the final iteration, the resulting image Mₙ₊₁, becomes the input image for the next iteration. This process continues for P 13 iterations to obtain a final encrypted image G 64. In order to restore the initial binary sequence (i.e., to decrypt G 64), it may be necessary to accurately and in precise sequence, consecutively execute in reverse all the iterative conversion function steps. Thus, if there were P 13 conversion iterations, it may be necessary to determine P 13 internal identifiers Kₙ 42, restore P 13 images Mₙ 62, and find P 13 transformation algorithms Aₙ 48. Without restoration of the unknown parameters of a concrete transformation iteration (Kₙ, Mₙ, A′ₙ, AV′ₙ, and length of the image), it may be impossible to execute the next reverse transformation iteration.

Each converted image, such as M′₁ 52, is comprised of a concatenation of a coded tag data element T″ 68, and either a transformed structural data element S′ 70 (in embodiments not employing internal identifiers Kᵢ 42), or a structural data element S″ 72 (in embodiments employing internal identifiers Kᵢ 42). Both S′ 70 and S″ 72 are comprised of sequences of logical scales LSᵢ 44 (not shown in FIG. 3) which contain information about the proper position (or distribution) of quants (or letters) 34 in the image M₀ 54 prior to conversion.

Upon each iteration of the conversion function, the structural data element S 12 may be quantized (divided into quants) with a stochastic quantization parameter m 36 to form a finite transformation alphabet AVₘ 46 and letter frequency. For the purposes of the quantization process, image Mᵢ 14, which may be a binary sequence of length q bits, is represented as a binary cartage

Mᵢ=<X₁, X₂, . . . , X_{q}>,

where XJε {0,1} and J=1,2, 3, . . . q.

Mᵢ may be presented as a cartage M′_{c} by a method of dividing (quantization) into consecutive groups with m bits in each, that is

M′_{c}(m)=<B₁,B₂,B₃, . . . , Bₖ>,

where q=m*k, and a separate quant (or letter) beginning with bit w will look like the following:

B_{b}=<X^{w},X_{w+1}, . . . ,X_{w+m-1}> and b=1, 2, 3, . . . , k.

The alphabet of the transformation AV 46 may be comprised of different values of quants B_{b}, the maximum number of which is 2^{m}. The number of different values B_{b} in a file of length q is referred to as the typeness of file ρₘ, where 1≦ρₘ≦2^{m}, and a multitude of the quants (or letters) makes the alphabet of the specific file

AV{M′_{c}(m), ρₘ,τ}, [referred to above and below as AV 46]

where τ is a current ordinal number of the division. The total number of divisions may be a stochastically selected number limited by constraining conditions. These conditions could include, for example, creating a final encrypted file/image of minimum length, or of length no greater than the original binary sequence, or other mathematical or logical criteria.

For example, following an iteration involving an algorithm which inverts quants, the transformed structural data element S′ 70 or structural data element S″ 72 may be comprised of a sequence of logical scales LS 44 of position coding

LS=<∝1,∝2,∝3, . . . ∝k>, . . . , where each value ∝b is defined as follows:

bit ∝b defines a position of a separate quant (or certain composition of a quant grouping) 34, which it (or a typical grouping) holds in transformed structural data element S′ 70 or structural data element S″ 72; and

with the assistance of one LS, a i^{st} file may be divided into two non-crossing cartages of the quants (or a group of quants), where

∝b=1 if quant B_{b} (or a group of quants) holds (corresponds to) position b, or

∝b=0 in the opposite case.

From the transformation alphabet AVₙ 46, a subset AV′ₙ (for example, 56) may be selected for inversion which meets the condition of the presented image M 14 in this alphabet (for example, maximum of redundancy). Image Mₙ 14 may be transformed with alphabet AV′ₙ 56 and a stochastically selected transformation algorithm A′ₙ 48 to obtain a converted image Mₙ₊₁ 52. There are a complex set of algorithms Lₘ 60 with which this transformation may be realized. One of these algorithms (A′ₙ ∈ Lₙ) can be selected in a particular manner upon each conversion iteration. The transformation algorithm A′ₙ 48 and alphabet AV′ₙ 56 may be selected stochastically, or, alternatively, based on constraining conditions such as achieving a minimum encrypted image/file length for different values of quantization parameter m 36 and number of iterations P 13. Selection of constraining conditions (for example, firmness or file size) could be accomplished with a slider in a user interface.

### EXAMPLE ONE

### Quantization and Logical Scale Formation

Consider this example employing a stochastically selected transformation algorithm A 48 in quantization and logical scale formation. Begin with the binary sequence

010110110011000111100011110100011100011110001110000111010011010,

and assume the quantization parameter m 36 was stochastically selected to be 3. Then dividing (quantizing) the binary sequence into quants (or letters) 34 of bit length three results in:

Seq₀: 010 110 110 011 000 111 100 011 110 100 011 100 011 110 001 110 000 111 010 011 010

Per the requirements of this hypothetical transformation algorithm A 48, a first logical scale LS₁ may be created by replacing with a unity bit each quant (or letter) corresponding to the first quant (in this case {010}) of the sequence S₀, and a zero bit for each quant (or letter) that does not. Sequence S₀ is then shortened by extracting that unity quant from each place it appears in sequence S₀, thereby forming sequence S₁. This results in:

LS₁: {100000000000000000101} Seq₁: {110 110 011 000 111 100 011 110 100 011 100 011 110 001 110 000 111 011}

The second quant (or letter) is 110. Second logical scale LS₂ and second sequence S₂ are similarly formed:

LS₂: {110000010000101000} Seq₂: {011 000 111 100 011 100 011 100 011 001 000 111 011}

The third quant is 011. Therefore third logical scale LS₃ and sequence S₃ are:

LS₃: {1000101010001} Seq₃: {000 111 100 100 100 001 000 111}

The fourth letter is 000. Therefore the fourth logical scale LS₄ is:

LS₄: {10000010} Seq₄: {111 100 100 100 001 111}

The fifth letter is 111. Therefore the fifth logical scale LS₅ is:

LS₅: {100001} Seq₅: 100 100 100 001.

The sixth letter is 100. Therefore the sixth logical scale LS₆ is:

LS₆: {1110} Seq₆: 001

The seventh letter is 001. Therefore the seventh logical scale LS₇ is:

LS₇: 1 Seq₇: 0

There is no need to create an eighth logical scale, because it is the last and eighth letter in a three-digit letter scheme and there is no zero bit in the seventh logical scale LS₇.

The transformed structural data element S′ 70 for this iteration then becomes a concatenation of the sequence of logical scales of position coding LSᵢ, or

S′=<LS₁,LS₂,LS₃,LS₄,LS₅,LS₆,LS₇>={100000000000000000101 110000010 00010100 010001010100011000001010000111101}.

The tag data element T 10 for this transformation will contain the information necessary to identify the transformation algorithm 48 employed and reverse this transformation process using the transformed structural data element S′ 70.

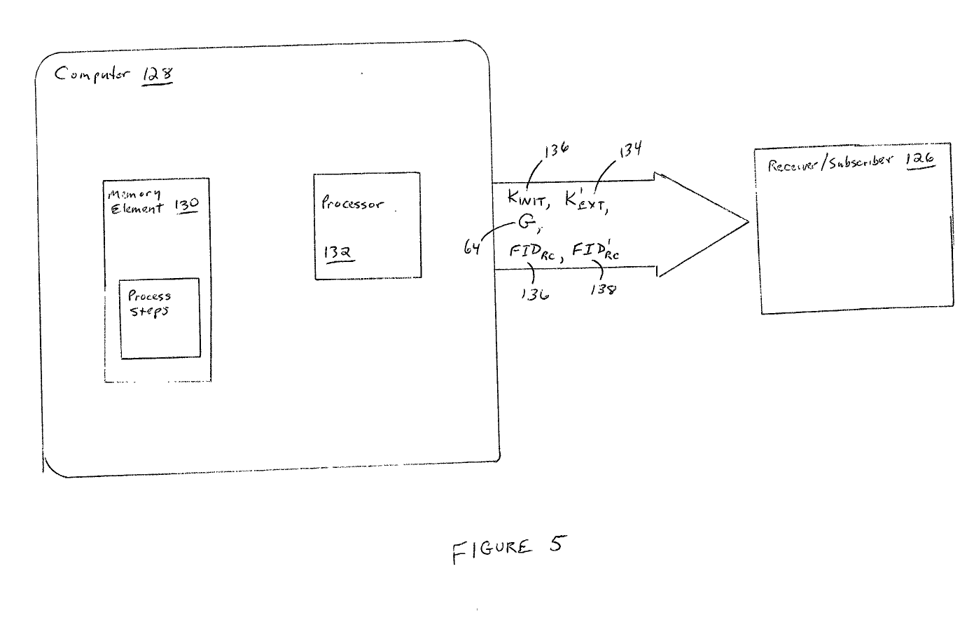

FIG. 4 is a detailed functional block diagram of a full embodiment of the R-conversion method. Not all the steps embodied in FIG. 4 are essential to the invention. Where possible, those optional steps which represent different embodiments of the invention are so designated. Additionally, executing the steps in orders other than the preferred order presented herein is possible, and should be evident to one skilled in the art.

As described above, one of the first steps involved in R-conversion is a step of forming an image Mₙ 74 based upon the binary sequence to be converted. Next, a step 76 of selecting a number of conversion function iterations P 13 is executed. As stated previously, the selecting of the number of conversion function iterations P 13 may be stochastic, or alternatively may be made in a manner to achieve a particular encryption firmness. Preferably, a determination 78 of whether internal identifiers Kᵢ 42 will be employed and extracted from the transformed structural data element S′ 70 is made early in the R-conversion process. This determination 78 is different from the determination 104 made upon every iteration whether to extract an internal identifier K 42 during that particular iteration. The extraction of an internal identifier K 42 is shown in FIG. 4 as occurring in step 106, but it may actually occur at the beginning of every iteration, upon stochastically selected iterations, or after the last iteration, depending upon conditions of information protection and routing strategy. That is, extracting an internal identifier K 42 depends upon the security level desired. Extracting sharply increases security, but leads to additional costs. In a preferred embodiment, internal identifiers are extracted 106 in approximately 75% of the iterations.

Following these determinations, a process step 80 is executed which determines whether any constraining criteria, such as the mathematical, logical or file size criteria described above, are present. If so, the quantization parameter m 36, transformation algorithm A 48, and transformation alphabet AV 46 may require defining 82 to satisfy the criteria, while simultaneously maintaining the greatest degree of stochasticism possible in the selection of these parameters. For example, if a constraining criteria is present such that the smallest possible final encrypted image G 64 is to be obtained, all the expected transformed file lengths for each combination of quantization parameter m 36 and algorithm A 48 may be computed, and then quantization parameter m 36 and algorithm A 48 chosen accordingly. If no constraining criteria are present (or the particular embodiment does not allow for such criteria), the quantization parameter m 36, transformation algorithm A 48, and transformation alphabet AV 46 are stochastically selected in step 84. Counter statistics step 86 may determine if the current iteration of the conversion process is the P^{th} (the last), and may keep a count the number of iterations having been performed.

Steps 88 and 90 are directed to another aspect of the invention providing for (optional) user authentication and digital signatures. User authentication and digital signatures may be implemented by stochastically determining 88 whether to insert user information into structural data element S 12 on a given iteration, and if determined that user information should be inserted, inserting 90 some unique user characteristics (i.e., birth date, job, height, etc.) into structural data element S 12, where it will be transformed with the other structural data element S 12 information. Other unique user information may include biometric data, such as information about a user's retina, fingerprint or bioelectric characteristics. Inserting 90 this information into structural data element S 12 necessitates an associated storage in tag data element T 10 an indicator 66 of what type of user information was inserted (if any), in order that reverse conversion can occur. An exceptional feature of this aspect of the invention lies in the fact that no person, even a recipient of the final encrypted image G 64, can know if there is user authentication & digital signing information in the final encrypted image G 64 until after decryption. Furthermore, the user authentication and digital signing information is impossible to change because it is stored “inside” the structural data element S 12, therefore, in order to alter it, one must “crack” the message.

Steps 92 and 94 refer to the quantization, logical scale formation, and transformed structural data element S′ 70 formation steps described above, both theoretically and in hypothetically in Example One. Following the forming 94 of transformed structural data element S′ 70, the bit length parameter 22 and shift parameter 20, which define the length and position within transformed structural data element S′ 70 of an internal identifier K 42, may optionally be selected in a stochastic manner in step 96. The internal identifier K 42 may then be scrambled (in step 98) by a scrambling function, resulting in a scrambled internal identifier K′ 118. The scrambling function may have been selected stochastically from a scrambling matrix. The scrambling matrix may be a binary matrix and a long term key which may be periodically changed. The scrambled internal identifier K′ 118 may then be used to code (in step 102) a portion of the tag data element T 10 (formed in step 100), thereby obtaining a partially coded tag data element T′ 120. Partially coded tag data element T′ 120 is preferably comprised of a coded portion and an original uncoded portion of tag data element T 10, and the coding comprises a logical XOR operation.

Following the coding step 102, it may be stochastically determined (in step 104) whether the internal identifier Kᵢ 42 should also be extracted during this iteration. This determination 104 may alternatively be made at other points, including the beginning of the iteration (in conjunction with step 78). If it is determined that an internal identifier K 42 should be extracted upon a particular iteration, the internal identifier K 42 is extracted (in step 106) from the transformed structural data element S′ 70, thereby obtaining structural data element S″ 72, and either the internal identifier K 42 or scrambled internal identifier K′ 118 is stored in a file of internal identifiers FID 122 or a file of scrambled internal identifiers FID′ 124.

### EXAMPLE TWO

### Internal Identifier Extraction

The extraction of an internal identifier Kᵢ 42 may be better understood with an example. Consider a transformed structural data element S′ 70 (such as the one formed in Example One), where S′ is comprised of binary string 10000000000000000010111000001000010100010001010100011000001010000111101. An internal identifier K 42 may be stochastically defined 96 as having a shift 20 of 15 bits, and a bit length 22 of 25 bits within the transformed structural data element S′ 70. Extracting this internal identifier K 42 from the transformed structural data element yields a K=0001011100000100001010001, and a structural data element S″ 72 where

S″=1000000000000000001010100011000001010000111101.

The R-conversion method also employs one or more external keys K^{x}ᵢ 40 to increase system security. The external key K^{x} 40 may be selected (in step 110) from a file of external keys K_{EXT} 120 stochastically upon each iteration, or alternatively only once whereby the same external key K^{x} 40 may be used for all conversion process iterations. The selected external key K^{x} 40 is used to code (in step 112) the portion of the partially coded tag data element T′ 120, preferably the portion not already coded by the scrambled internal identifier K′ 118, in order to obtain coded tag data element T″ 68. An identifier 28 of which external key K^{x} 40 was selected is required to be saved in the tag data element T 10.

Following the coding step 112, image Mₙ₊₁ is formed as a concatenation of coded tag data element T″ 68, and either transformed structural data element S′ 70 (if no extraction 106 was made) or structural data element S″ 72 (if an extraction 106 was made). Image Mₙ₊₁ may then be used as the input image for the next conversion function iteration, unless the current iteration is the P^{th}, in which case Mₙ₊₁ will be the final encrypted image G 64.

FIG. 5 illustrates how the R-conversion system may be adapted for use in a configuration wherein a receiver 126 is located remotely from a user. Depicted is a computer 128 including a memory element 130 adapted to store computer executable process steps, and a processor 132 adapted to execute computer executable process steps and to communicate on a network. The computer executable process steps comprise the R-conversion method steps described above. In this embodiment, the processor transmits to the receiver 126, independent of the present R-conversion, a converted file of external keys K′_{EXT} 134 which has been formed by R-converting the file of external keys K_{EXT} 120 with an initial key K_{INIT} 136 (which is also sent to the receiver 126 independently and securely, but not R-converted). Upon completion of the present R-conversion, the file of internal identifiers FID 122 or file of scrambled internal identifiers FID′ 124 may be R-converted with an external key K^{x} 40 to obtain an R-converted file of internal identifiers FID_{RC} 136 or R-converted file of scrambled internal identifiers FID′_{RC} 138. The resulting file of internal identifiers FID_{RC} 136 or R-converted file of scrambled internal identifiers FID′_{RC} 138, and the final encrypted image G 64, are transmitted to the receiver 126. The receiver 126 uses the initial key K_{INIT} 136 to locally decrypt the converted file of external keys K′_{EXT} 134. Once a new initial key is received, using a stochastic period, the older initial key may be obsoleted and destroyed. The receiver 126 may then decrypt the final encrypted image G 64, using the decrypted file of external keys K_{EXT} 120 and decrypted file of internal identifiers FID 122 or file of scrambled internal identifiers FID′ 124, thereby obtaining the initial image M₀ 54 and initial binary sequence.

### EXAMPLE THREE

### A Simple Reverse Transformation

Described herein is a simple reverse transformation example, which employs the hypothetical variables defined above in Example Two. Assume a receiver 126 has received a final encrypted image G 64 and has extracted internal identifier K 42 from FID 122 as follows:

S = 100000000000000000101010001100000101000011110
1, and
K = 0001011100000100001010001.

Further assume that within the tag data element T 10, the following information can be found:

(a) shift of the internal identifier (length is known to be 15 following extraction from FID 122);

(b) quants (010 110 011 000 111 100 001); and

(c) first logical scale length (21).

Then, by inserting the internal identifier K 42 back into structural data element S, the following sequence is obtained:

100000000000000000101110000010000101000100010101000110000010100001 11101

Next, the logical scales of position coding may be derived by dividing up S:

a) Using the known first logical scale length, yields

LS₁=100000000000000000101;

b) Because there are 18 nulls in the first logical scale, the second logical scale will be 18 bits long, or

LS₂=110000010000101000;

c) The remaining scales are derived in a similar fashion:

LS₃=1000101010001

LS₄=10000010

LS₅=100001

LS₆=1110

LS₇=1

d) The first bit in the first logical scale 1, therefore the first three bits in the initial sequence will equal to the first quant. Therefore Seq=010.

e) The second bit in the first scale is 0, therefore the second scale is reviewed. The first bit in the second scale is 1, therefore the next three bits in the initial sequence will equal to the second quant. Seq=010110.

f) The third bit in the first scale is 0, therefore the second scale is reviewed. The second bit in the second scale is 1, therefore the next three bits in the initial sequence will be equal to the second quant. Seq=010110110.

g) The fourth bit in the first scale is 0, therefore the second scale is reviewed. The third bit in the second scale is 0, therefore the third scale is reviewed. The first bit in the third scale is 1, therefore the next three bits in the initial sequence will be equal to the third quant. Seq=010110110011.

Continuing in this fashion will eventually derive the initial binary sequence, in this example:

Seq=010110110011000111100011110100011100011110001110000111010011010.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. Method of structurally converting a binary sequence into an encrypted final image G, the structural conversion comprising the steps of:
forming an image M of the binary sequence as a concatenation of a tag data element T and structural data element S, tag data element T comprising information necessary to reverse a conversion process, structural data element S comprising a sequence of logical scales of position coding;
selecting a number of conversion function iterations P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
selecting an external key K^{x};
forming tag data element T;
coding the tag data element T with external key K^{x} to obtain coded tag data element T″;
repeating the steps of the conversion function upon a converted image M′ comprised of a concatenation of the coded tag data element T″ and the transformed structural data element S′;
and forming the encrypted final image G as a concatenation of the coded tag data element T″ and the transformed structural data element S′ created upon the P^{th} iteration of the conversion function.

2. Method of structurally converting a binary sequence into an encrypted final image G, said structural conversion comprising the steps of:
forming an image M of the binary sequence as a concatenation of a tag data element T and structural data element S, tag data element T comprising information necessary to reverse the conversion process, structural data element S comprising a sequence of logical scales of position coding;
selecting a number of conversion function iterations P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
stochastically selecting a bit length parameter and a shift parameter which define an internal identifier K within transformed structural data element S′;
forming tag data element T;
coding a portion of the tag data element T with internal identifier K to obtain a partially coded tag data element T′;
selecting an external key K^{x};
coding the partially coded tag data element T′ with external key K^{x} to obtain coded tag data element T″;
determining whether to extract internal identifier K from transformed structural data element S′, and if determined necessary, extracting the internal identifier K from transformed structural data element S′ to obtain structural data element S″ and storing internal identifier K in a file of internal identifiers FID;
repeating the steps of the conversion function upon a converted image M′ comprised of a concatenation of the coded tag data element T″ and either transformed structural data element S′ if internal identifier K was not extracted, or structural data element S″ if internal identifier K was extracted;
and forming the encrypted final image G as a concatenation of the coded tag data element T″ and either transformed structural data element S′ if internal identifier K was not extracted, or structural data element S″ if internal identifier K was extracted.

3. Method of structurally converting a binary sequence into an encrypted final image G, said structural conversion comprising the steps of:
forming an image M of the binary sequence as a concatenation of a tag data element T and structural data element S, tag data element T comprising information necessary to reverse the conversion process, structural data element S comprising a sequence of logical scales of position coding;
selecting a number of conversion function iterations P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
stochastically selecting a bit length parameter and a shift parameter which define an internal identifier K within transformed structural data element S′;
scrambling internal identifier K with a scrambling function to obtain a scrambled internal identifier K′;
forming tag data element T;
coding a portion of the tag data element T with scrambled internal identifier K′ to obtain a partially coded tag data element T′;
selecting an external key K^{x};
coding the partially coded tag data element T′ with external key K^{x} to obtain coded tag data element T″;
determining whether to extract internal identifier K from transformed structural data element S′, and if determined necessary, extracting the internal identifier K from transformed structural data element S′ to obtain structural data element S″ and storing scrambled internal identifier K′ in a file of internal identifiers FID;
repeating the steps of the conversion function upon a converted image M′ comprised of a concatenation of the coded tag data element T″ and either transformed structural data element S′ if internal identifier K was not extracted, or structural data element S″ if internal identifier K was extracted;
and forming the encrypted final image G as a concatenation of the coded tag data element T″ and either transformed structural data element S′ if internal identifier K was not extracted, or structural data element S″ if internal identifier K was extracted.

4. The method of claim 2, further comprising the steps of:
structurally converting the file of internal identifiers FID to obtain a converted file of internal identifiers FID′, wherein a tag data element formed during the structural conversion of the file of internal identifiers FID is coded with an external key selected stochastically from a multitude of external keys in an external key file K_{EXT}; and
optionally transmitting the encrypted final image G and structurally converted file of internal identifiers FID′ to a subscriber or receiver.

5. The method of claim 1, wherein the external key K^{x} is selected from a multitude of external keys in an external key file K_{EXT}.

6. The method of claim 1, wherein the selection of external key K^{x} is a stochastic selection.

7. The method of claim 1, wherein a same external key K^{x} is selected for use in all iterations.

8. The method of claim 1, wherein a different external key K^{x} is selected upon each iteration.

9. The method of claim 1, wherein the external key K^{x} is entered by a user during the conversion and reverse conversion process.

10. The method of claim 5, further comprising the steps of:
structurally converting the external key file K_{EXT} to obtain a structurally converted external key file; and
transmitting to a subscriber the structurally converted external key file and an initial key K_{INIT} required to reverse the structural conversion of the structurally converted external key file to obtain the external key file K_{EXT}.

11. The method of claim 1, wherein the selection of transformation algorithm A may be a stochastic selection.

12. The method of claim 1, wherein the selection of transformation algorithm A may depend upon adherence to a mathematical criterion.

13. The method of claim 1, wherein the selection of transformation algorithm A may depend upon adherence to a logical criterion.

14. The method of claim 1, wherein the selection of transformation algorithm A may depend upon adherence to a file size criteria for encrypted final image G.

15. The method of claim 1, wherein the predefined set of transformation algorithms L may be supplemented.

16. The method of claim 1, wherein the selection of a number of conversion steps P may be a stochastic selection.

17. The method of claim 1, wherein the selection of a number of conversion steps P may depend upon adherence to a mathematical criterion.

18. The method of claim 1, wherein the selection of a number of conversion steps P may depend upon adherence to a logical criterion.

19. The method of claim 1, wherein the selection of a number of conversion steps P may depend upon adherence to a file size criteria for encrypted final image G.

20. The method of claim 1, wherein the alphabet of transformation AV is comprised of letters or quants, each letter or quant comprising a segment of structural data element S.

21. The method of claim 2, further comprising the step of determining upon which iterations, if any, internal identifiers are to be extracted.

22. The method of claim 3, further comprising the step of determining upon which iterations, if any, internal identifiers are to be extracted.

23. The method of claim 20, wherein a number of bits in each letter or quant is stochastically selected.

24. The method of claim 20, wherein a number of bits in each letter or quant may depend upon adherence to a mathematical criterion.

25. The method of claim 20, wherein a number of bits in each letter or quant may depend upon adherence to a logical criterion.

26. The method of claim 20, wherein a number of bits in each letter or quant may depend upon adherence to a file size criteria for encrypted final image G.

27. The method of claim 1, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
a length of a first logical scale of position coding;
an indicator of user information;
the alphabet of transformation AV; and
other transformation algorithm A parameters.

28. The method of claim 2, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
an indicator of user information;
the alphabet of transformation AV;
a length of a first logical scale of position coding;
other transformation algorithm A parameters;
the bit internal identifier K length and shift parameters; and
an indicator of internal identifier K extraction.

29. The method of claim 3, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
an indicator of user information;
the alphabet of transformation AV;
a length of a first logical scale of position coding;
other transformation algorithm A parameters;
an indicator of the scrambling function selected;
the bit internal identifier K length and shift parameters; and
an indicator of internal identifier K extraction.

30. The method of claim 3, wherein the scrambling function is selected from a scrambling matrix comprised of a predefined set of scrambling functions.

31. The method of claim 30, wherein the predefined set of scrambling functions is changed periodically.

32. The method of claim 1, wherein the conversion function further comprises the step of:
determining whether to insert user information into structural data element S, and inserting user information into structural data element S if determined necessary, thereby providing a means for user authentication and digital signing.

33. The method of claim 2, wherein the conversion function further comprises the step of:
determining whether to insert user information into structural data element S, and inserting user information into structural data element S if determined necessary, thereby providing a means for user authentication and digital signing.

34. The method of claim 3, wherein the conversion function further comprises the step of:
determining whether to insert user information into structural data element S, and inserting user information into structural data element S if determined necessary, thereby providing a means for user authentication and digital signing.

35. Computer executable process steps stored on a computer readable medium, the computer executable process steps for structurally converting a binary sequence into an encrypted final image G, the computer executable process steps comprising:
forming an image M of the binary sequence as a concatenation of a tag data element T and structural data element S, tag data element T comprising information necessary to reverse a conversion process, structural data element S comprising a sequence of logical scales of position coding;
selecting a number of conversion steps P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
selecting an external key K^{x};
forming tag data element T;
coding the tag data element T with external key K^{x} to obtain coded tag data element T″;
repeating the steps of the conversion function upon a converted image M′ comprised of a concatenation of the coded tag data element T″ and the transformed structural data element S′;
and forming the encrypted final image G as a concatenation of the coded tag data element T″ and the transformed structural data element S′created upon the P^{th} iteration of the conversion function.

36. Computer executable process steps stored on a computer readable medium, the computer executable process steps for structurally converting a binary sequence into an encrypted final image G, the computer executable process steps comprising:
forming an image M of the binary sequence as a concatenation of a tag data element T and structural data element S, tag data element T comprising information necessary to reverse the conversion process, structural data element S comprising a sequence of logical scales of position coding;
selecting a number of conversion steps P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′comprised of a sequence of the logical scales of position coding;
stochastically selecting a bit length parameter and a shift parameter which define an internal identifier K within transformed structural data element S′;
forming tag data element T;
coding a portion of the tag data element T with internal identifier K to obtain a partially coded tag data element T′;
selecting an external key K^{x};
coding the partially coded tag data element T′ with external key K^{x} to obtain coded tag data element T″;
stochastically determining whether to extract internal identifier K from transformed structural data element S′, and if determined necessary, extracting the internal identifier K from transformed structural data element S′ to obtain structural data element S″ and storing internal identifier K in a file of internal identifiers FID;
performing the steps of the conversion function upon a converted image M′ comprised of a concatenation of the coded tag data element T″ and either transformed structural data element S′ if internal identifier K was not extracted, or structural data element S″ if internal identifier K was extracted;
and forming the encrypted final image G as a concatenation of the coded tag data element T″ and either transformed structural data element S′ if internal identifier K was not extracted, or structural data element S″ if internal identifier K was extracted.

37. Computer executable process steps stored on a computer readable medium, the computer executable process steps for structurally converting a binary sequence into an encrypted final image G, the computer executable process steps comprising:
forming an image M of the binary sequence as a concatenation of a tag data element T and structural data element S, tag data element T comprising information necessary to reverse the conversion process, structural data element S comprising a sequence of logical scales of position coding;
selecting a number of conversion steps P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
stochastically selecting a bit length parameter and a shift parameter which define an internal identifier K within transformed structural data element S′;
scrambling internal identifier K with a scrambling function to obtain a scrambled internal identifier K′, forming tag data element T;
coding a portion of the tag data element T with scrambled internal identifier K′ to obtain a partially coded tag data element T′;
selecting an external key K^{x};
coding the partially coded tag data element T′ with external key K^{x} to obtain coded tag data element T″;
stochastically determining whether to extract internal identifier K from transformed structural data element S′, and if determined necessary, extracting the internal identifier K from transformed structural data element S′ to obtain structural data element S″ and storing scrambled internal identifier K′ in a file of internal identifiers FID;
performing the steps of the conversion function upon a converted image M′ comprised of a concatenation of the coded tag data element T″ and either transformed structural data element S′ if internal identifier K was not extracted, or structural data element S″ if internal identifier K was extracted;
and forming the encrypted final image G as a concatenation of the coded tag data element T″ and either transformed structural data element S′ if internal identifier K was not extracted, or structural data element S″ if internal identifier K was extracted.

38. The computer executable process steps stored on a computer readable medium of claim 35, wherein the external key K^{x} is selected from a multitude of external keys in an external key file K_{EXT}.

39. The computer executable process steps stored on a computer readable medium of claim 35, wherein the selection of the external key K^{x} is a stochastic selection.

40. The computer executable process steps stored on a computer readable medium of claim 35, wherein a same external key K^{x} is selected for use in all iterations.

41. The computer executable process steps stored on a computer readable medium of claim 35, wherein a different external key K^{x} is selected upon each iteration.

42. The computer executable process steps stored on a computer readable medium of claim 35, wherein the external key K^{x} is entered by a user during the conversion and reverse conversion process.

43. The computer executable process steps stored on a computer readable medium of claim 35, wherein the selection of transformation algorithm A may be a stochastic selection.

44. The computer executable process steps stored on a computer readable medium of claim 35, wherein the selection of transformation algorithm A may depend upon adherence to a mathematical criterion.

45. The computer executable process steps stored on a computer readable medium of claim 35, wherein the selection of transformation algorithm A may depend upon adherence to a logical criterion.

46. The computer executable process steps stored on a computer readable medium of claim 35, wherein the selection of transformation algorithm A may depend upon adherence to a file size criteria for encrypted final image G.

47. The computer executable process steps stored on a computer readable medium of claim 35, wherein the predefined set of transformation algorithms L may be supplemented.

48. The computer executable process steps stored on a computer readable medium of claim 35, wherein the selection of a number of conversion steps P may be a stochastic selection.

49. The computer executable process steps stored on a computer readable medium of claim 35, wherein the selection of a number of conversion steps P may depend upon adherence to a mathematical criterion.

50. The computer executable process steps stored on a computer readable medium of claim 35, wherein the selection of a number of conversion steps P may depend upon adherence to a logical criterion.

51. The computer executable process steps stored on a computer readable medium of claim 35, wherein the selection of a number of conversion steps P may depend upon adherence to a file size criteria for encrypted final image G.

52. The computer executable process steps stored on a computer readable medium of claim 35, wherein the alphabet of transformation AV is comprised of letters or quants, each letter or quant comprising a segment of structural data element S.

53. The computer executable process steps stored on a computer readable medium of claim 52, wherein a number of bits in each letter or quant is stochastically selected.

54. The computer executable process steps stored on a computer readable medium of claim 52, wherein a number of bits in each letter or quant may depend upon adherence to a mathematical criterion.

55. The computer executable process steps stored on a computer readable medium of claim 52, wherein a number of bits in each letter or quant may depend upon adherence to a logical criterion.

56. The computer executable process steps stored on a computer readable medium of claim 52, wherein a number of bits in each letter or quant may depend upon adherence to a file size criteria for encrypted final image G.

57. The computer executable process steps stored on a computer readable medium of claim 35, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
a length of a first logical scale of position coding;
the alphabet of transformation AV; and
other transformation algorithm A parameters.

58. The computer executable process steps stored on a computer readable medium of claim 36, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
the alphabet of transformation AV;
a length of a first logical scale of position coding;
other transformation algorithm A parameters;
internal identifier K bit length and shift parameters; and
an indicator of internal identifier K extraction.

59. The computer executable process steps stored on a computer readable medium of claim 37, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
the alphabet of transformation AV;
a length of a first logical scale of position coding;
other transformation algorithm A parameters;
an indicator of the scrambling function selected;
internal identifier K bit length and shift parameters; and
an indicator of internal identifier K extraction.

60. The computer executable process steps stored on a computer readable medium of claim 37, wherein the scrambling function is selected from a scrambling matrix comprised of a predefined set of scrambling functions.

61. The computer executable process steps stored on a computer readable medium of claim 60, wherein the predefined set of scrambling functions is changed periodically.

62. An apparatus for structurally converting a binary sequence into an encrypted final image G, comprising:
a memory element for storing computer executable process steps;
a processor for executing computer executable process steps;
computer executable process steps comprising:
forming an image M of the binary sequence as a concatenation of a tag data element T and structural data element S, tag data element T comprising information necessary to reverse a conversion process, structural data element S comprising a sequence of logical scales of position coding;
selecting a number of conversion steps P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
selecting an external key K^{x};
forming tag data element T;
coding the tag data element T with external key K^{x} to obtain coded tag data element T″;
repeating the steps of the conversion function upon a converted image M′ comprised of a concatenation of the coded tag data element T″ and the transformed structural data element S′;
and forming the encrypted final image G as a concatenation of the coded tag data element T″ and the transformed structural data element S′ created upon the P^{th} iteration of the conversion function.

63. An apparatus for structurally converting a binary sequence into an encrypted final image G, comprising:
a memory element for storing computer executable process steps;
a processor for executing computer executable process steps;
computer executable process steps comprising:
forming an image M of the binary sequence as a concatenation of a tag data element T and structural data element S, tag data element T comprising information necessary to reverse the conversion process, structural data element S comprising a sequence of logical scales of position coding;
selecting a number of conversion steps P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
stochastically selecting a bit length parameter and a shift parameter which define an internal identifier K within transformed structural data element S′;
forming tag data element T;
coding a portion of the tag data element T with internal identifier K to obtain a partially coded tag data element T′;
selecting an external key K^{x};
coding the partially coded tag data element T′ with external key K^{x} to obtain coded tag data element T″;
stochastically determining whether to extract internal identifier K from transformed structural data element S′, and if determined necessary, extracting the internal identifier K from transformed structural data element S′ to obtain structural data element S″ and storing internal identifier K in a file of internal identifiers FID;
performing the steps of the conversion function upon a converted image M′ comprised of a concatenation of the coded tag data element T″ and either transformed structural data element S′ if internal identifier K was not extracted, or structural data element S″ if internal identifier K was extracted;
and forming the encrypted final image G as a concatenation of the coded tag data element T″ and either transformed structural data element S′ if internal identifier K was not extracted, or structural data element S″ if internal identifier K was extracted.

64. The apparatus of claim 63, wherein:
the processor is adapted to communicate on a network; and
the computer executable process steps further comprise:
structurally converting the file of internal identifiers FID to obtain a converted file of internal identifiers FID′, wherein a tag data element formed during the structural conversion of the file of internal identifiers FID is coded with an external key selected stochastically from a multitude of external keys in an external key file K_{EXT}; and
transmitting the encrypted final image G and structurally converted file of internal identifiers FID′ to a subscriber or receiver.

65. An apparatus for structurally converting a binary sequence into an encrypted final image G, comprising:
a memory element for storing computer executable process steps;
a processor for executing computer executable process steps; computer executable process steps comprising:
forming an image M of the binary sequence as a concatenation of a tag data element T and structural data element S, tag data element T comprising information necessary to reverse the conversion process, structural data element S comprising a sequence of logical scales of position coding;
selecting a number of conversion steps P to be performed;
iteratively executing P times a conversion function comprised of the following steps:
selecting a transformation algorithm A from a predefined set of transformation algorithms L;
selecting an alphabet of transformation AV based upon the structural data element S;
applying algorithm A and alphabet AV to structural data element S to form a plurality of logical scales of position coding;
forming a transformed structural data element S′ comprised of a sequence of the logical scales of position coding;
stochastically selecting a bit length parameter and a shift parameter which define an internal identifier K within transformed structural data element S′;
scrambling internal identifier K with a scrambling function to obtain a scrambled internal identifier K′;
forming tag data element T;
coding a portion of the tag data element T with scrambled internal identifier K′ to obtain a partially coded tag data element T′; selecting an external key K^{x};
coding the partially coded tag data element T′ with external key K^{x} to obtain coded tag data element T″;
stochastically determining whether to extract internal identifier K from transformed structural data element S′, and if determined necessary, extracting the internal identifier K from transformed structural data element S′ to obtain structural data element S″ and storing scrambled internal identifier K′ in a file of internal identifiers FID;
performing the steps of the conversion function upon a converted image M′ comprised of a concatenation of the coded tag data element T″ and either transformed structural data element S′ if internal identifier K was not extracted, or structural data element S″ if internal identifier K was extracted;
and forming the encrypted final image G as a concatenation of the coded tag data element T″ and either transformed structural data element S′ if internal identifier K was not extracted, or structural data element S″ if internal identifier K was extracted.

66. The apparatus of claim 65, wherein:
the processor is adapted to communicate on a network; and
the computer executable process steps further comprise:
structurally converting the file of internal identifiers FID to obtain a converted file of internal identifiers FID′, wherein a tag data element formed during the structural conversion of the file of internal identifiers FID is coded with an external key selected stochastically from a multitude of external keys in an external key file K_{EXT}; and
transmitting the encrypted final image G and structurally converted file of internal identifiers FID′ to a subscriber or receiver.

67. The apparatus of claim 62, wherein the external key K^{x} is selected from a multitude of external keys in an external key file K_{EXT}.

68. The apparatus of claim 62, wherein the selection of external key K^{x} is a stochastic selection.

69. The apparatus of claim 62, wherein a same external key K^{x} is selected for use in all iterations.

70. The apparatus of claim 62, wherein a different external key K^{x} is selected upon each iteration.

71. The apparatus of claim 62, wherein the external key K^{x} is entered by a user during the conversion and reverse conversion process.

72. The apparatus of claim 67, wherein:
the processor is adapted to communicate on a network; and
the computer executable process steps further comprise:
structurally converting the external key file K_{EXT} to obtain a structurally converted external key file; and
transmitting to a subscriber the structurally converted external key file and an initial key K_{INIT} required to reverse the structural conversion of the structurally converted external key file to obtain the external key file K_{EXT}.

73. The apparatus of claim 62, wherein the selection of transformation algorithm A may be a stochastic selection.

74. The apparatus of claim 62, wherein the selection of transformation algorithm A may depend upon adherence to a mathematical criterion.

75. The apparatus of claim 62, wherein the selection of transformation algorithm A may depend upon adherence to a logical criterion.

76. The apparatus of claim 62, wherein the selection of transformation algorithm A may depend upon adherence to a file size criteria for encrypted final image G.

77. The apparatus of claim 62, wherein the predefined set of transformation algorithms L may be supplemented.

78. The apparatus of claim 62, wherein the selection of a number of conversion steps P may be a stochastic selection.

79. The apparatus of claim 62, wherein the selection of a number of conversion steps P may depend upon adherence to a mathematical criterion.

80. The apparatus of claim 62, wherein the selection of a number of conversion steps P may depend upon adherence to a logical criterion.

81. The apparatus of claim 62, wherein the selection of a number of conversion steps P may depend upon adherence to a file size criteria for encrypted final image G.

82. The apparatus of claim 62, wherein the alphabet of transformation AV is comprised of letters or quants, each letter or quant comprising a segment of structural data element S.

83. The apparatus of claim 82, wherein a number of bits in each letter or quant is stochastically selected.

84. The apparatus of claim 82, wherein a number of bits in each letter or quant may depend upon adherence to a mathematical criterion.

85. The apparatus of claim 82, wherein a number of bits in each letter or quant may depend upon adherence to a logical criterion.

86. The apparatus of claim 82, wherein a number of bits in each letter or quant may depend upon adherence to a file size criteria for encrypted final image G.

87. The apparatus of claim 62, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
a length of a first logical scale of position coding;
the alphabet of transformation AV; and
other transformation algorithm A parameters.

88. The apparatus of claim 63, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
the alphabet of transformation AV;
a length of a first logical scale of position coding;
other transformation algorithm A parameters;
the bit internal identifier K length and shift parameters; and
an indicator of internal identifier K extraction.

89. The apparatus of claim 63, wherein the information necessary to reverse the conversion process stored in tag data element T may comprise one or more of the following:
an indicator of whether a current iterative step is the P^{th} iteration;
an indicator of whether the selected external key K^{x} is to be used for all P iterations;
an indicator of the selected external key K^{x};
an indicator of the selected transformation algorithm A;
the alphabet of transformation AV;
a length of a first logical scale of position coding;
other transformation algorithm A parameters;
an indicator of the scrambling function selected;
the bit internal identifier K length and shift parameters; and
an indicator of internal identifier K extraction.

90. The apparatus of claim 65, wherein the scrambling function is selected from a scrambling matrix comprised of a predefined set of scrambling functions.

91. The apparatus of claim 90, wherein the predefined set of scrambling functions is changed periodically.
